(19) United States
(12) Patent Application Publication
(10) Pub. No.: US 2008/0061751 A1
(43) Pub. Date: Mar. 13, 2008

(54) SELECTION DEVICE AND DRIVING SYSTEM UTILIZING THE SAME

(75) Inventors: Chin-Fa Kao, Taipei (TW); Chih-Shun Lee, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEYOND INNOVATION TECHNOLOGY CO., LTD., Taipei (TW)

(21) Appl. No.: 11/623,175

(22) Filed: Jan. 15, 2007

(30) Foreign Application Priority Data
Sep. 7, 2006 (TW) 95133025

(51) Int. Cl. G05F 1/00

(52) U.S. Cl. 323/271

(57) ABSTRACT

A selection device for selecting an output state of a switch device is disclosed. The selection device includes a power source, a rectification element, a driving unit, and a control unit. The switch device includes an upper-arm switch and a lower-arm switch. The power source provides a power signal. The rectification element is coupled to the power source. The driving unit includes a totem circuit coupled to the upper-arm switch and a storage element coupled to the rectification element. The control unit transmits the power signal to the driving unit by the rectification element according to a control signal. The upper-arm switch is driven by the totem circuit to select the output state when the power signal is received by the driving unit.

### BACKGROUND OF THE INVENTION

1. Field of the Invention

The invention relates to a selection device and a driving system utilizing the same, and more particularly to a selection device and a driving system that provide bootstrap power for driving an upper-arm switch and a lower-arm switch.

2. Description of the Related Art

A conventional driving system typically comprises an N type field-effect transistor (NMOSFET) and a P type field-effect transistor (PMOSFET). NMOSFET and PMOSFET serving as a rectification switch are alternately turned on. PMOSFET is referred to as an upper-arm switch and NMOSFET is referred to as a lower-arm switch. The upper-arm switch and the lower-arm switch are alternately turned on to provide an alternating current to a load, such as DC to AC inverter or other inverters. Since the upper-arm switch and the lower-arm switch require different voltage levels, a selection device is utilized to drive the upper-arm switch such that the rectification switch operates normally.

FIG. 1a is a conventional selection device for selecting an output state of a switch device. The switch device 12 comprises an upper-arm switch 121 and a lower-arm switch 122. The Upper-arm switch 121 is a PMOSFET and the lower-arm switch 122 is an NMOSFET. The selection device 10 comprises resistors 101 and 102, a zener diode 104, and a capacitor 105. The selection device 10 drives the upper-arm switch 121 according to a control signal OUTB. The lower-arm switch 122 is driven according to a control signal OUTA. Thus, the switch device 12 operates normally to generate an output signal S_{OUT}.

FIG. 1b is a timing diagram of control signals OUTA and OUTB. In period P1, control signals OUTA and OUTB are high such that lower-arm switch 122 is turned on and upper-arm switch 121 is turned off Thus, output signal S_{OUT} is low.

Additionally, when upper-arm switch 121 and lower-arm switch 122 are simultaneously turned on, a shoring effect occurs. Thus, dead time, such as periods P2 and P4, is added to control signals OUTA and OUTB. During the dead time, control signal OUTA is low and control signal OUTB is high such that upper-arm switch 121 and lower-arm switch 122 are turned off Thus, upper-arm switch 121 and lower-arm switch 122 do not be damaged because upper-arm switch 121 and lower-arm switch 122 do not turn on.

In period P3, control signals OUTA and OUTB are low, upper-arm switch 121 is turned on and lower-arm switch 122 is turned off Thus, output signal S_{OUT} is high.

When transistors are turned on, impedances of P type transistors exceed impedances of N type transistors due to manufacturing procedures. Thus, effects and temperature characteristics of P type transistors are worse than N type transistors. Since characteristics of upper-arm switch 121 are worse than lower-arm switch 122, providing a selection device to drive a switch device composed of N type transistors is an important topic.

### BRIEF SUMMARY OF THE INVENTION

A selection device is provided. An exemplary embodiment of a selection device selecting an output state of a switch device comprises a power source, a rectification element, a driving unit, and a control unit. The switch device comprises an upper-arm switch and a lower-arm switch. The power source provides a power signal. The rectification element is coupled to the power source. The driving unit comprises a totem circuit coupled to the upper-arm switch and a storage element coupled to the rectification element. The control unit transmits the power signal to the driving unit by the rectification element according to a control signal. The upper-arm switch is driven by the totem circuit to select the output state when the power signal is received by the driving unit.

Another exemplary embodiment of a selection device selecting an output state of a switch device comprises a power source, a driving unit, and a control unit. The switch device comprises an upper-arm switch and a lower-arm switch. The upper-arm and the lower-arm switches are NMOS transistors. The power source provides a power signal. The driving unit is coupled to the power source and the upper-arm switch. The control unit is coupled to the driving unit. The control unit transmits the power signal to the driving unit according to a control signal. When receiving the power signal, the driving unit drives the upper-arm switch to select the output state.

Driving systems are also provided. An exemplary embodiment of a driving system driving a load comprises a control device, a switch device, a selection device, and a power converter. The control device generates a first control signal and a second control signal. The switch device comprises an upper-arm switch and a lower-arm switch. The upper-arm switch is operated according to a driving signal and the lower-arm switch is operated according to the second control signal such that the switch device generates an output signal. The selection device comprises a power source providing a power signal, a rectification element coupled to the power source, a driving unit, and a control unit. The driving unit comprises a totem circuit coupled to the upper-arm switch and a storage element coupled to the rectification element. The control unit transmits the power signal to the driving unit by the rectification element according to the first control signal. The totem circuit outputs the driving signal when the power signal is received by the driving unit. The power converter drives the load according to the output signal.

Another exemplary embodiment of a driving system driving a load comprises a control device, a selection device, a switch device, and a power converter. The control device generates a first control signal and a second control signal. The selection device comprises a power source providing a power signal, a driving unit coupled to the power source, and a control unit. The control unit transmits the power signal to the driving unit according to the first control signal. The driving unit outputs a driving signal when receiving the power signal. The switch device comprises an upper-arm switch and a lower-arm switch. The upper-arm and the lower-arm switches are NMOS transistors. The upper-arm switch generates an output signal according to a driving signal. The power converter drives the load according to the output signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1a is a conventional selection device to select an output state of a switch device;

FIG. 1b is a timing diagram of control signals OUTA and OUTB;

FIG. 2a is a schematic diagram of an exemplary embodiment of a driving system;

FIG. 2b is a timing diagram of control signals S_{C1} and S_{C2};

FIG. 3a is a schematic diagram of an exemplary embodiment of the signal generator;

FIGS. 3b˜3d are schematic diagrams of another exemplary embodiments of the signal generator;

FIG. 3e is a timing diagram of control signals S_{C1} and S_{C2};

FIG. 4a is a schematic diagram of an exemplary embodiment of the power converter;

FIG. 4b is a schematic diagram of another exemplary embodiment of the power converter; and

FIG. 5 is a schematic diagram of an exemplary embodiment of the power switching circuit.

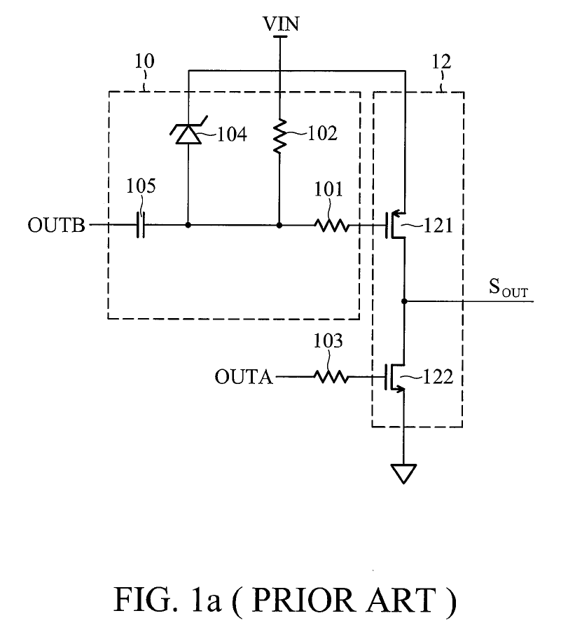

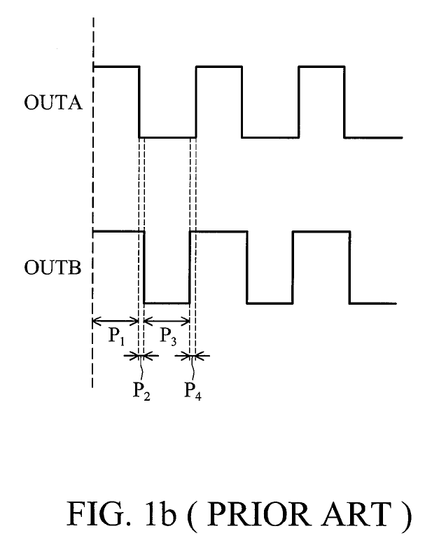

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The configurations and operations of a driving system and a selection device are explained in greater detail with reference to related figures. The same element utilizes the same symbol.

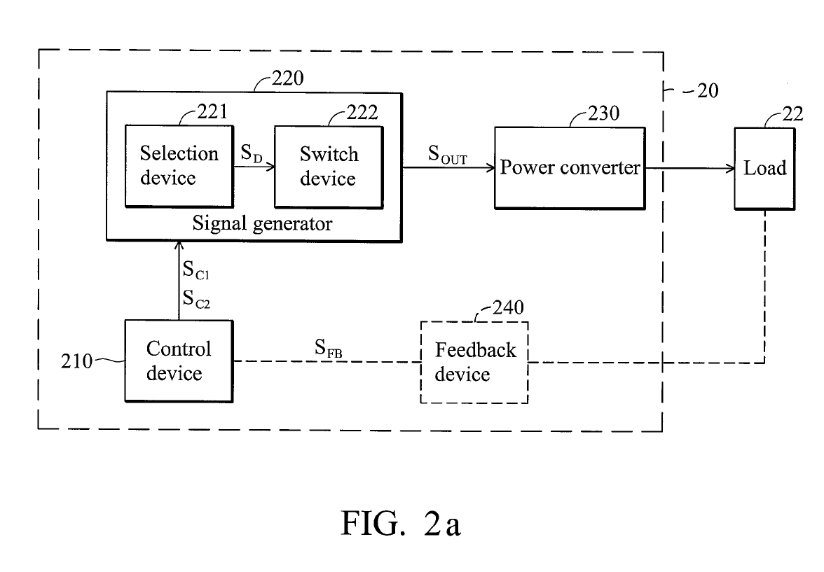

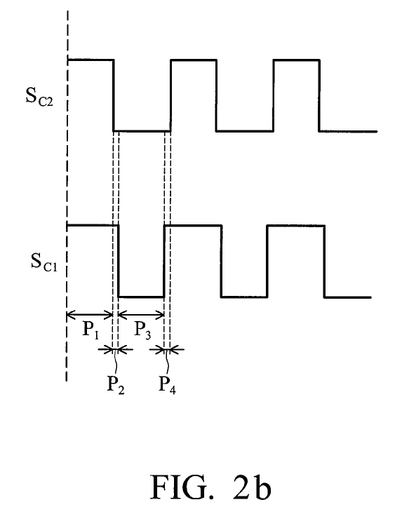

FIG. 2a is a schematic diagram of an exemplary embodiment of a driving system. The driving system 20 drives a load 22 and comprises a control device 210, a signal generator 220, and a power converter 230. The control device 210 generates two control signals S_{C1} and S_{C2}. The signal generator 220 generates an output signal S_{OUT} according to control signals S_{C1} and S_{C2}. The power converter 230 drives load 22 according to the output signal S_{OUT}. The load 22 is a light emitting diode (LED) or a fluorescent lamp.

The control signals S_{C1} and S_{C2} and output signal S_{OUT} are pulse width modulation (PWM) signals shown in FIG. 2b. The driving system 20 further comprises a feedback device 240. The feedback device 240 generates a feedback signal S_{FB} to the control device 210 according to an operation state of load 22 such that the control device 210 adjusts the control signals S_{C1} and S_{C2} according to the feedback signal S_{FB}. In another embodiment, the feedback device 240 is omitted to retrench cost.

In this embodiment, the signal generator 220 comprises a selection device 221 and a switch device 222. The Switch device 222 comprises an upper-arm switch 31 and a lower-arm switch 33.The selection device 221 outputs a driving signal S_{D} according to the control signal S_{C1}. The switch device 222 generates the output signal S_{OUT} according to the driving signal S_{D}. In another embodiment, the switch device 222 generates the output signal S_{OUT} according to the driving signal S_{D} and the control signal S_{C2}.

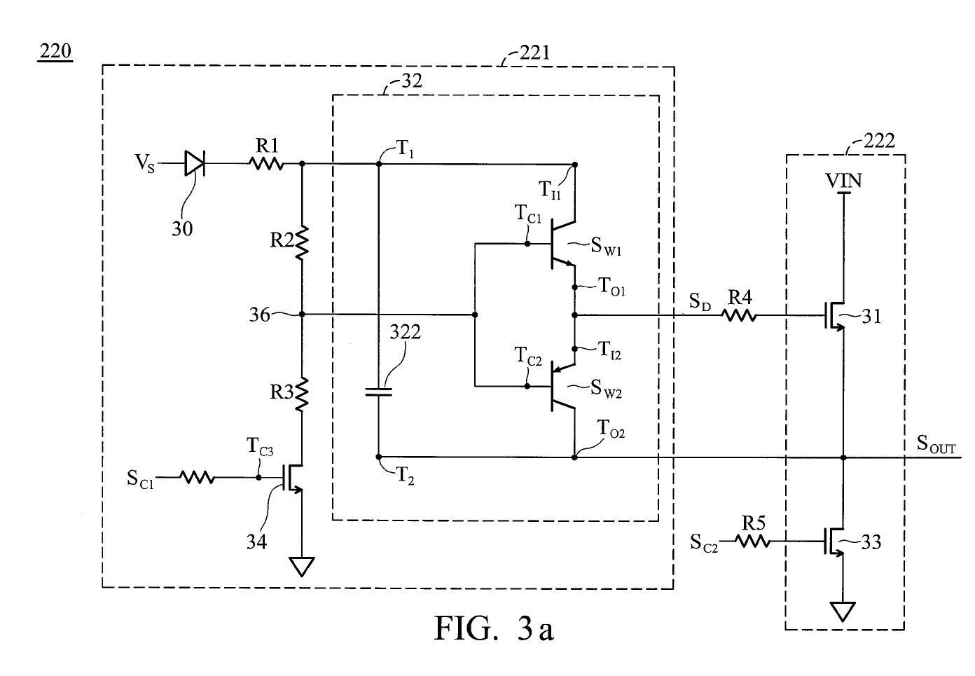

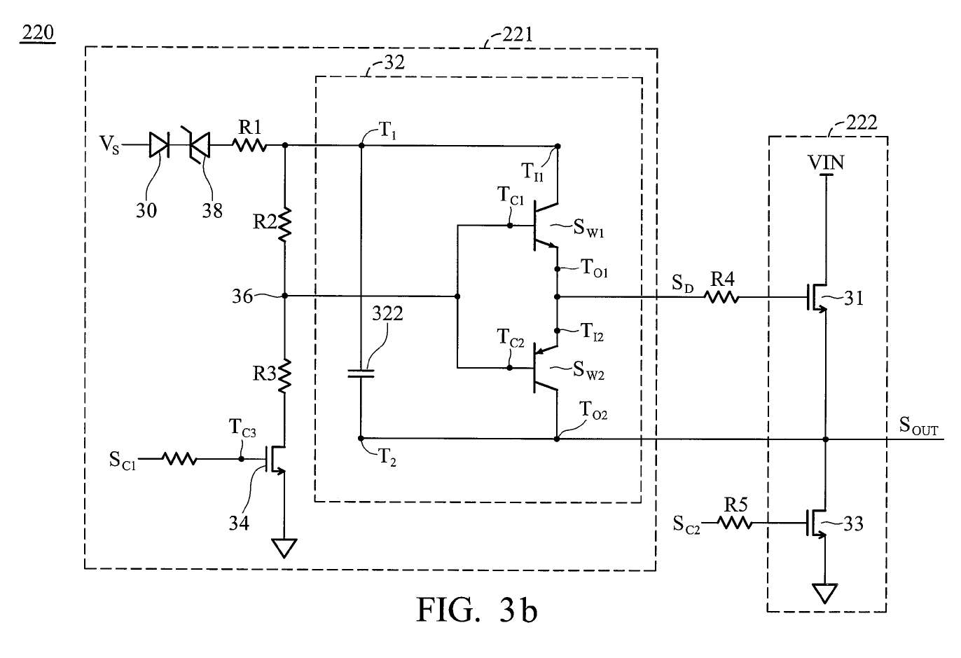

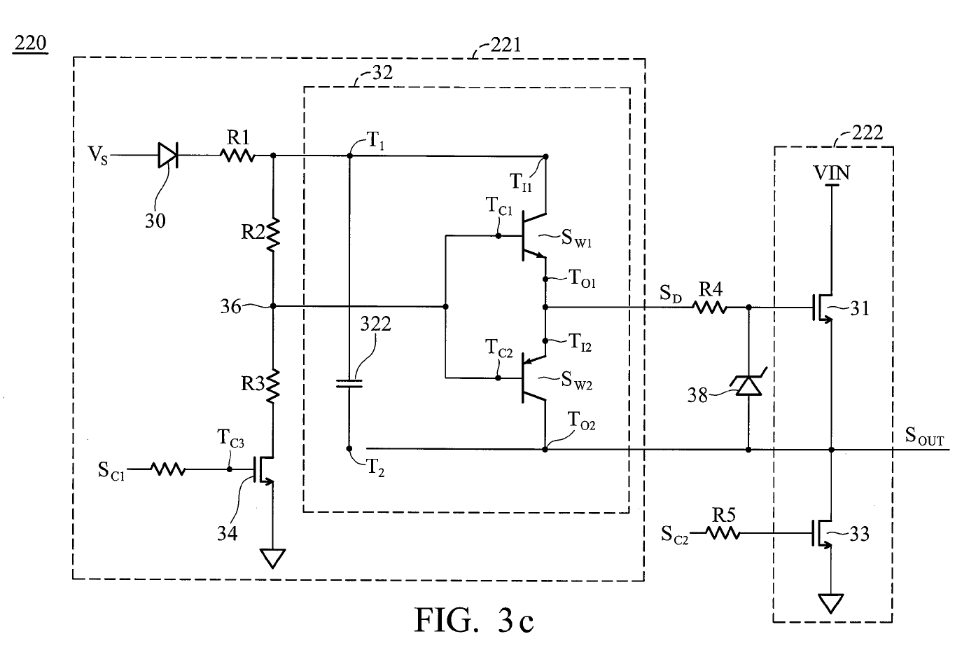

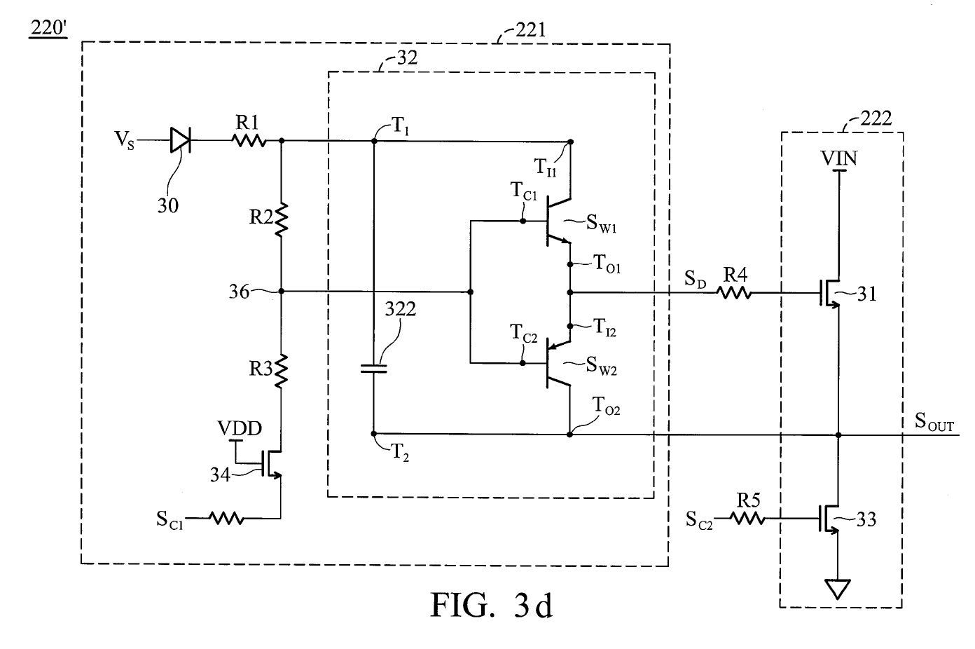

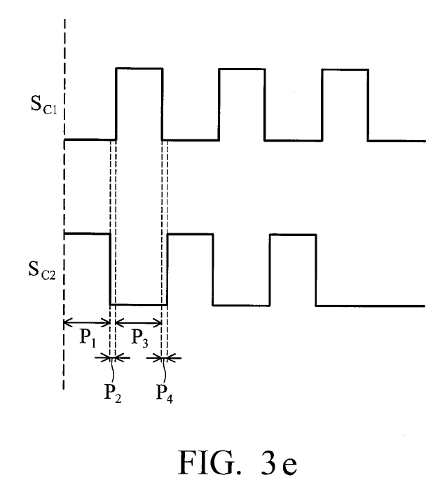

FIG. 3a is a schematic diagram of an exemplary embodiment of the signal generator. The selection device 221 comprises a power source Vs, a rectification element 30, a driving unit 32, and a control unit 34. The power source Vs provides a power signal. The driving unit 32 is coupled to the power source Vs by the rectification element 30. The control unit 34 transmits the power signal to the driving unit 32 according to the control signal S_{C1}. The driving unit 32 outputs the driving signal S_{D} when receiving the power signal of the power source Vs. In this embodiment, the rectification element 30 is a diode. The driving unit 32 comprises two switches S_{W}1 and S_{W}2 and a storage element 322. A totem circuit is composed of the switches S_{W}1 and S_{W}2 for coupling an upper-arm switch 31. The storage element 322 is a capacitor coupled to rectification element 30. In this embodiment, rectification element 30 comprises an anode receiving the power signal of the power source Vs and a cathode coupled to a first terminal T1 of the storage element 322.

The switch S_{W}1 is an npn bipolar junction transistor (BJT) and comprises a control terminal T_{C1} coupled to the control unit 34, an input terminal T_{I1} coupled to the rectification element 30 and a first terminal T1 of storage element 322, and an output terminal T_{O1} coupled to the upper-arm switch 31. In this embodiment, control terminal T_{C1} is a base of npn BJT, input terminal T_{I1} is a collector of npn BJT, and output terminal T_{O1} is an emitter of npn BJT.

The switch S_{W}2 is a pnp bipolar junction transistor (BJT) and comprises a control terminal T_{C2} coupled to the control unit 34, an input terminal T_{I2} coupled to the upper-arm switch 31, and an output terminal T_{O2} coupled to a second terminal T2 of the storage element 322. In this embodiment, control terminal T_{C2} is a base of pnp BJT, input terminal T_{I2} is an emitter of pnp BJT, and output terminal T_{O2} is a collector of pnp BJT.

The control unit 34 is a switch comprising a control terminal T_{C3} receiving the control signal S_{C1}. In this embodiment, the control unit 34 is an NMOS transistor comprising a gate receiving control signal S_{C1}.

Additionally, the upper-arm switch 31 generates the output signal S_{OUT} according to the driving signal S_{D}. In this embodiment, the upper-arm switch 31 and the lower-arm switch 33 are NMOS transistors. In another embodiment, the upper-arm switch 31 or the lower-arm switch 33 is an NMOS transistor, an npn bipolar junction transistor (BJT), an insulated gate bipolar transistor (IGBT) or other switches that are well known to those skilled in the field.

The lower-arm switch 33 is operated according to the control signal S_{C2}. The upper-arm switch 31 and lower-arm switch 33 are operated according to control the signals S_{C1} and S_{C2}, respectively for controlling level of output signal S_{OUT}. Additionally, signal generator 220 further comprises resistors R1˜R5.

The configuration and operation of signal generator 220 is explained in greater detail with reference to FIGS. 2a, 2b, and 3a. In period P1, the control signals S_{C1} and S_{C2} are high (level of point 36 is low) such that the control unit 34 is turned on. When the upper-arm switch 31 is turned off and the lower-arm switch 33 is turned on, the power signal provided by power source Vs charges the storage element 322 by the rectification element 30, the resistor R1, and the lower-arm switch 33. In period P2 (dead time), the upper-arm switch 31 and lower-arm switch 33 are turned off

In period P3, the control signals S_{C1} and S_{C2} are low such that control unit 34 is turned off. The power signal provided by power source Vs turns on switch S_{W1} of the totem circuit by rectification element 30, resistors R1 and R2. Since the storage element 322 provides the storing voltage to drive the upper-arm switch 31, the upper-arm switch 31 is turned on and the lower-arm switch 33 is turned off In period P4 (dead time), the upper-arm switch 31 and lower-arm switch 33 are turned off Since the upper-arm switch 31 and lower-arm switch 33 are alternately driven, the output signal S_{OUT} is generated. The power converter 230 drives load 22 according to the output signal S_{OUT}.

Additionally, the switch device 222 may be damaged due to the higher power signal provided by the power source Vs. Thus, the signal generator 220 further comprises a protection unit 38 shown in FIG. 3b. The protection unit 38 is coupled between the rectification element 30 and the driving unit 32. The protection unit 38 comprises a zener diode that limits voltage level provided to the switch device 222 for avoiding higher voltage level. In another embodiment, the protection unit 38 shown in FIG. 3c is coupled to the driving circuit 32 and the upper-arm switch 31 to achieve the above efficacy.

FIG. 3d is a schematic diagram of another exemplary embodiment of the signal generator. FIG. 3d is similar to FIG. 3a with the exception that control unit 34 is an NMOS transistor and the NOMOS transistor comprises a gate receiving voltage VDD. The control signal S_{C1} is received by a drain or a source of the NMOS transistor.

FIG. 3e is a timing diagram of control signals S_{C1} and S_{C2}. In this embodiment, a phase difference between control signals S_{C1} and S_{C2} is approximately 180°.

With reference to FIGS. 3d and 3e, the control signal S_{C1} is low such that level of point 36 is low, in the period P1. Thus, the driving signal S_{D} is low such that the upper-arm switch 31 is turned off. Since the control signal S_{C2} is high, the lower-arm switch 33 is turned on. Thus, the output signal S_{OUT} is low such that the storage element 322 is charged.

To avoid that the upper-arm switch 31 and lower-arm switch 33 are simultaneously turned on, the control signal S_{C2} has dead time, such as the periods P2 and P4. In the period P2 or P4, the control signals S_{C1} and S_{C2} are low such that the upper-arm switch 3 1 and lower-arm switch 33 are turned off

In the period P3, the control signal S_{C1} is high such that level of point 36 is high. Because the storage element 322 stores voltage, the upper-arm switch 31 is turned on such that the output signal S_{OUT} is high. Since the control signal S_{C2} is low, the lower-arm switch 33 is turned off Thus, the upper-arm switch 31 and lower-arm switch 33 are alternately turned on.

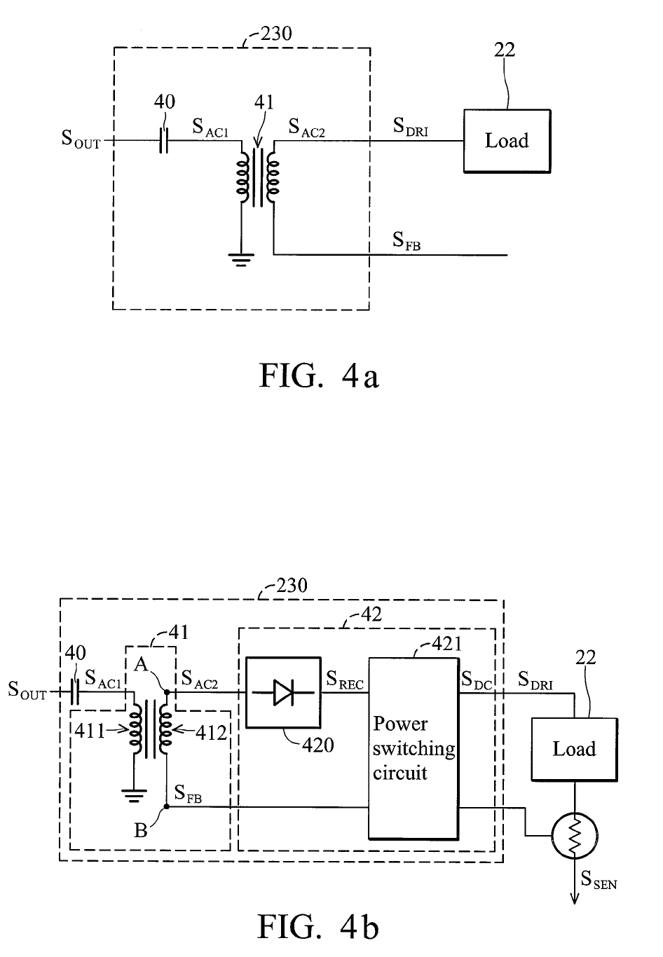

FIG. 4a is a schematic diagram of an exemplary embodiment of the power converter. The Power converter 230 comprises a capacitor 40 and a transformer 41. The capacitor 40 filters direct current (DC) component of the output signal S_{OUT} of switch device 222 to generate an alternating current (AC) signal S_{AC1}. Transformer 41 transforms alternating current signal S_{AC1} into an alternating current signal S_{AC2} for driving the load 22. In this embodiment, the load 22 is a fluorescent lamp.

FIG. 4b is a schematic diagram of another exemplary embodiment of a power converter. The power converter 230 comprises a capacitor 40, a transformer 41, and a converter 42. The capacitor 40 filters direct current (DC) component of the output signal S_{OUT} of switch device 222 to generate an alternating current (AC) signal S_{AC1}. Transformer 41 comprises a primary side 411 receiving alternating current signal S_{AC1} and a secondary side 412 generating an alternating current signal S_{AC2} according to alternating current signal S_{AC1}.

The converter 42 transforms alternating current signal S_{AC2} into a direct current signal S_{DC} for driving the load 22. In this embodiment, the load 22 is a light emitting diode (LED). The converter 42 comprises a bridge rectifier 420 and a power switching circuit 421.

The bridge rectifier 420 is coupled to a first terminal A of secondary side 412 for transforming alternating current signal S_{AC2} into a rectification signal S_{REC}. The power switching circuit 421 is coupled to a second terminal B of secondary side 412 for transforming rectification signal S_{REC} into direct current signal S_{DC}.

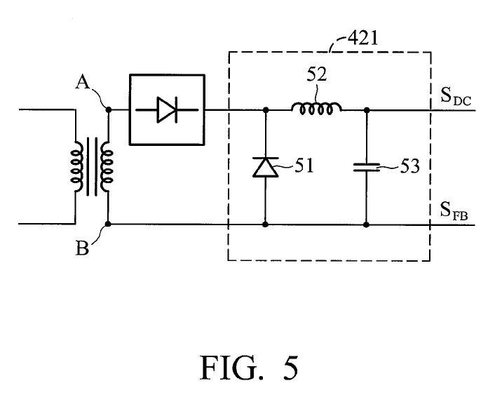

FIG. 5 is a schematic diagram of an exemplary embodiment of the power switching circuit. The power switching circuit 421 comprises a diode 51, an inductor 52, and a capacitor 53. The diode 51 comprises an anode coupled to the second terminal B of secondary side 412 and a cathode receiving rectification signal S_{REC}. The inductor 52 comprises a first terminal coupled to the cathode of the diode 51. The capacitor 53 is coupled between a second terminal of inductor 52 and the second terminal B of the secondary side 412.

In summary, the driving system of the invention drives the upper-arm switch and the lower-arm switch by the driving unit and alternately turns on the upper-arm switch and the lower-arm switch for generating an alternating current signal to driving the load.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A selection device for selecting an output state of a switch device, wherein the switch device comprises an upper-arm switch and a lower-arm switch, comprising:
a power source providing a power signal;
a rectification element coupled to the power source;
a driving unit comprising a totem circuit coupled to the upper-arm switch and a storage element coupled to the rectification element, and
a control unit transmitting the power signal to the driving unit by the rectification element according to a control signal, wherein the upper-arm switch is driven by the totem circuit to select the output state when the driving unit receives the power signal.

2. The selection device as claimed in claim 1, wherein the storage element is a capacitor.

3. The selection device as claimed in claim 1, wherein the rectification element is a diode comprising an anode coupled to the power source and a cathode coupled to the storage element.

4. The selection device as claimed in claim 1, wherein the totem circuit comprises:
a first switch comprising a first control terminal coupled to the control unit, a first input terminal coupled to the rectification element and a first terminal of the storage element, and a first output terminal coupled to the upper-arm switch; and
a second switch comprising a second control terminal coupled to the control unit, a second input terminal coupled to the upper-arm switch, and a second output terminal coupled to a second terminal of the storage element.

5. The selection device as claimed in claim 4, wherein the first switch is an npn bipolar junction transistor (BJT) and the second switch is an pnp bipolar junction transistor.

6. The selection device as claimed in claim 1, wherein the control unit is a switch comprising a control terminal receiving the control signal.

7. The selection device as claimed in claim 6, wherein the control unit is an NMOS transistor comprising a gate receiving the control signal.

8. The selection device as claimed in claim 6, wherein the control unit is an NMOS transistor and the control signal is received by a drain or a source of the NMOS transistor.

9. The selection device as claimed in claim 1, wherein the upper-arm switch is an NMOS transistor, an npn bipolar junction transistor (BJT), or an insulated gate bipolar transistor (IGBT) and the lower-arm switch is an NMOS transistor, an npn bipolar junction transistor (BJT), or an insulated gate bipolar transistor (IGBT).

10. The selection device as claimed in claim 1, further comprising a protection unit coupled between the rectification element and the driving unit, wherein the protection unit comprises a zener diode.

11. The selection device as claimed in claim 1, further comprising a protection unit coupled between the totem circuit and the upper-arm switch, wherein the protection unit comprises a zener diode.

12. A selection device for selecting an output state of a switch device, wherein the switch device comprises an upper-arm switch and a lower-arm switch and the upper-arm and the lower-arm switches are NMOS transistors, comprising:
a power source providing a power signal;
a rectification element;
a driving unit coupled to the upper-arm switch and coupled to the power source through the rectification element; and
a control unit coupled to the driving unit, wherein the control unit transmits the power signal to the driving unit according to a control signal and when receiving the power signal, the driving unit drives the upper-arm switch to select the output state.

13. The selection device as claimed in claim 12, wherein the driving unit comprises a totem circuit coupled to the upper-arm switch and a storage element coupled to the rectification element, wherein the storage element is a capacitor.

14. The selection device as claimed in claim 13, wherein the totem circuit comprises:
a first switch comprising a first control terminal coupled to the control unit, a first input terminal coupled to the rectification element and a first terminal of the storage element, and a first output terminal coupled to the upper-arm switch; and
a second switch comprising a second control terminal coupled to the control unit, a second input terminal coupled to the upper-arm switch, and a second output terminal coupled to a second terminal of the storage element.

15. The selection device as claimed in claim 12, wherein the control unit is an NMOS transistor comprising a gate receiving the control signal.

16. The selection device as claimed in claim 12, wherein the control unit is an NMOS transistor and the control signal is received by a drain or a source of the NMOS transistor.

17. The selection device as claimed in claim 12, further comprising a protection unit coupled between the power source and the driving unit, wherein the protection unit comprises a zener diode.

18. The selection device as claimed in claim 13, further comprising a protection unit coupled to the driving unit and the upper-arm switch, wherein the protection unit comprises a zener diode.

19. A driving system for driving a load, comprising:
a control device generating a first control signal and a second control signal;
a switch device comprising an upper-arm switch and a lower-arm switch, wherein the upper-arm switch is operated according to a driving signal and the lower-arm switch is operated according to the second control signal such that the switch device generates an output signal,
a selection device comprising a power source providing a power signal, a rectification element coupled to the power source, a driving unit, and a control unit, wherein the driving unit comprises a totem circuit coupled to the upper-arm switch and a storage element coupled to the rectification element, the control unit transmits the power signal to the driving unit by the rectification element according to the first control signal, and the totem circuit outputs the driving signal when the power signal is received by the driving unit; and
a power converter driving the load according to the output signal.

20. The driving system as claimed in claim 19, wherein the storage element is a capacitor, the rectification element is a diode comprising an anode coupled to the power source and a cathode coupled to the storage element.

21. The driving system as claimed in claim 19, wherein the totem circuit comprises:
a first switch comprising a first control terminal coupled to the control unit, a first input terminal coupled to the rectification element and a first terminal of the storage element, and a first output terminal coupled to the upper-arm switch; and
a second switch comprising a second control terminal coupled to the control unit, a second input terminal coupled to the upper-arm switch, and a second output terminal coupled to a second terminal of the storage element.

22. The driving system as claimed in claim 21, wherein the first switch is an npn bipolar junction transistor (BJT) and the second switch is an pnp bipolar junction transistor.

23. The driving system as claimed in claim 19, wherein the control unit is a switch comprising a control terminal receiving the control signal.

24. The driving system as claimed in claim 19, wherein the upper-arm switch is an NMOS transistor, an npn bipolar junction transistor (BJT), or an insulated gate bipolar transistor (IGBT) and the lower-arm switch is an NMOS transistor, an npn bipolar junction transistor (BJT), or an insulated gate bipolar transistor (IGBT).

25. The driving system as claimed in claim 19, wherein the load is a light emitting diode (LED).

26. The driving system as claimed in claim 19, wherein the load is a fluorescent lamp.

27. The driving system as claimed in claim 19, wherein the selection device further comprises a protection unit coupled between the rectification element and the driving unit, and the protection unit comprises a zener diode.

28. The driving system as claimed in claim 19, wherein the selection device further comprises a protection unit coupled to the totem circuit and the upper-arm switch, and the protection unit comprises a zener diode.
